(19) United States
(12) Patent Application Publication
(10) Pub. No.: US 2017/0300948 A1
(43) Pub. Date: Oct. 19, 2017

(54) Systems and Methods for Predicting Purchase Behavior Based on Consumer Transaction Data in a Geographic Location

(71) Applicant: MASTERCARD INTERNATIONAL INCORPORATED, Purchase, NY (US)

(72) Inventors: Rohit Chauhan, Somers, NY (US); Po Hu, Norwalk, CT (US)

(21) Appl. No.: 15/131,664

(22) Filed: Apr. 18, 2016

(51) Int. Cl. G06Q 30/02; G06Q 10/08

(52) U.S. Cl. CPC G06Q 30/0205; G06Q 30/0259; G06Q 10/087; G06Q 30/0201

(57) ABSTRACT

Systems and methods are provided for use in predicting purchases in regions based on payment account transaction data from in and around the regions. One exemplary method includes generating a purchase propensity model based on historic transaction data and determining a recent sales value of the region based on a set of transactions that occurred in the region during a recent time interval. A set of consumer accounts that include transactions in the region during the recent time interval is determined. The computing device calculates consumer propensity scores for the consumer accounts based on the purchase propensity model. The propensity scores are combined into an overall purchase propensity for the region. The overall purchase propensity and recent sales value of the region are used to determine a predicted sales value of the region, whereby businesses in the region make business decisions confident that the predicted sales value is accurate.

### FIELD

The present disclosure generally relates to systems and methods for predicting purchasing behavior in a region based on purchase propensity models, wherein the purchase propensity models are generated based on past transaction data.

### BACKGROUND

This section provides background information related to the present disclosure which is not necessarily prior art.

Payment account transactions are employed ubiquitously in commerce, whereby consumers purchase products (e.g., goods and/or services), through use of payment accounts. The sheer volume of payment account transactions yields large quantities of transaction data, which may be collected and stored by parties/facilitators of the transactions. As facilitators of large quantities of payment transactions, payment networks may collect and store transaction data for a variety of reasons, including to permit authorization, clearing and settlement, and to perform certain analytics on the historical transaction data.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in predicting purchase behavior in regions;

FIG. 2 is a block diagram of a computing device that may be used in the exemplary system of FIG. 1; and

FIG. 3 is an exemplary method that may be implemented in connection with the system of FIG. 1 for predicting purchase behavior of consumers within regions based on historic transaction data.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Payment account transactions are pervasive throughout the world of commerce, and they result in vast amounts of transaction data. The transaction data may be collected and analyzed by parties/facilitators to the transactions, and patterns within the data may be observed. The patterns may provide useful information to a variety of parties, including merchants, advertisers, marketers, etc. Uniquely, the systems and methods herein are capable of predicting future purchase behavior in a region, based on the payment account transaction data. In particular, a prediction engine creates purchase propensity models from historic transaction data and applies the models to most recent transaction data for a region, resulting in a predicted overall purchase propensity for the region. The predicted overall purchase propensity may include predictions for specific merchants within the region and/or different merchant categories within the region. The predicted purchase propensity may then be used for a variety of purposes, including targeting advertising in the region, determining where resupply of goods/materials is needed, etc.

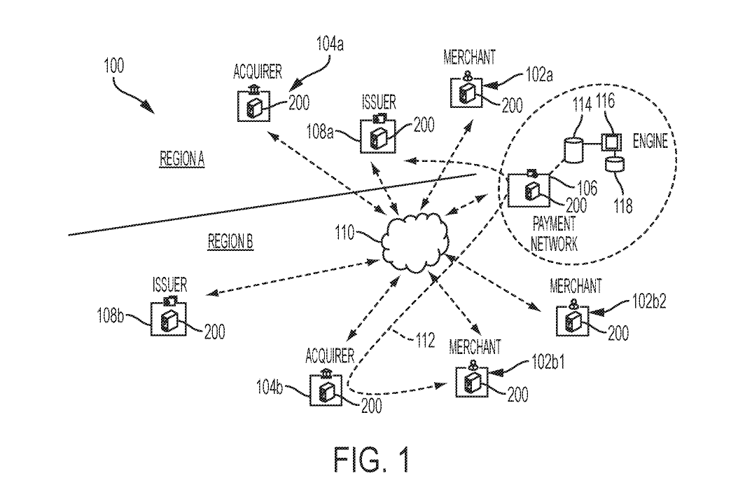

FIG. 1 illustrates an exemplary system 100, in which one or more aspects of the present disclosure may be implemented. Although the system 100 is presented in one arrangement, other embodiments may include the parts of the system 100 (or other parts) arranged otherwise depending on, for example, alternative regional groupings, differing transactional roles between parts of the system 100, additional parties to transactions, etc.

The system 100 generally includes a merchants 102a, 102b1, and 102b2, acquirers 104a and 104b, a payment network 106, and issuers 108a and 108b, each coupled to (and in communication with) network 110. The network 110 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, network 110 may include multiple different networks, such as a private payment transaction network made accessible by the payment network 106 to the acquirers 104a and 104b and the issuers 108a and 108b and, separately, the public Internet, which may provide interconnection between the merchants 102a, 102b1, and 102b2 and the acquirers 104a and 104b (as appropriate), etc.

As shown, the system 100 also includes separate regions A and B. The regions A and B do not limit communication and/or transactions between parts of system 100, but rather they generally serve as boundaries. Regions A and B may be provided or arranged in any conventional or desired manner (e.g., geographically, organizationally, functionally, etc.), that may further play one or more roles in predicting purchases and/or sales at other merchants in the same one or more of the regions A and B or in other related regions. For instance, transaction data may be gathered from the merchants 102b1 and 102b2 in region B that indicates a statistical likelihood that, after buying groceries at merchant 102b1, a consumer will buy gasoline at merchant 102b2. Different statistical indications may be found within each of the regions A and B (or within other regions) such that different predictions may be made and different actions taken based on the predictions. Additionally or alternatively, predictions may be made based on statistical relationships between purchases at merchant 102a in region A and purchases at merchants 102b1 and 102b2 in region B.

Again, it should be appreciated that the regions A and B may be any different type of geographical, organizational, or functional division of parts of the system 100 (or other parts not shown). In particular, regions as used herein may be defined by area codes, postal codes, states, territories, countries, continents, etc. Alternatively (or additionally), regions may be defined by other logical or organizational divisions as well, such as separate divisions or business units of a company, separate agencies in a governmental entity, or the like (whereby such regions may even overlap in geography). Further, different regions may suggest different purchase propensity patterns, or not.

Generally in the system 100, a consumer (not shown) completes purchase transactions for products with one or more of the merchants 102a, 102b1, and 102b2 using a payment account associated with the consumer. In connection therewith, the merchants 102a, 102b1, and 102b2, the acquirers 104a and 104b, the payment network 106, and the issuers 108a and 108b (as appropriate) cooperate, in response to purchase requests from the consumer, to complete the payment account transactions for purchase of the products.

As an example, a consumer from region A may initiate a transaction by presenting a payment device (e.g., a credit card, a debit card, a fob, a smartcard, a web-based e-wallet application, etc.) to the merchant 102b1. The merchant 102b1, in turn, reads the payment device and/or otherwise receives payment account information from the consumer, and then communicates an authorization request to the acquirer 104b (i.e., the acquirer associated with the merchant 102b1 in region B), as shown in FIG. 1 by reference to path 112. The acquirer 104b, in turn, communicates the authorization request through the payment network 106 (e.g., through MasterCard®, VISA®, Discover®, American Express®, etc.) to the issuer 108a (i.e., the issuer associated with the payment account of the consumer in region A). In turn, the issuer 108a sends a reply (i.e., authorizing or declining the transaction) back to the merchant 102b1, along the path 112, which permits the merchant 102b1 to conclude or end the transaction.

If the transaction is authorized (and concluded by the merchant 102b1), the transaction is later settled by and between the parts of system 100, generally in combination with multiple other transactions involving the acquirer 104b and/or issuer 108a. In particular, the merchant 102b1 sends its payment account transactions to the acquirer 104b, for example, at the end of the day, or within a predefined interval. This includes information for each transaction associated with the merchant 102b1, including, for example, an account number or other ID, an amount of the transaction, a merchant name, a merchant ID, a merchant location, transaction type, etc. (broadly, transaction data). In turn, the acquirer 104b reconciles the sent transactions and sends them on to the payment network 106 (i.e., to a clearing aspect of the payment network 106), etc., again along path 112. The payment network 106 then settles the transactions by debiting funds from appropriate accounts at the issuer 108a (as defined by clearing records received from the acquirer 104b) and crediting the funds to accounts associated with the acquirer 104b (e.g., for merchant 102b1, etc.) for the net amount of the transactions less any interchange and/or network fees charged by the payment network 106. Finally, the issuer 108a records the transactions against the accounts issued to its consumers (including the account for the consumer in the above example), and the acquirer 104b credits the merchant's account. This also applies to transactions involving the merchants 102a and 102b2, the acquirer 104a and issuer 108b.

Transaction data is generated, collected, and stored as part of the above exemplary interactions among the merchant 102b1, the acquirer 104b, the payment network 106, the issuer 108a, and the consumer. The transaction data includes a plurality of transaction records, one for each transaction, or attempted transaction. The transaction records, in this exemplary embodiment, are stored at least by the payment network 106 (e.g., in a data structure associated with the payment network 106, etc.). In particular in the system 100, the payment network 106 stores the transaction data (and associated records) in a transaction data structure 114. Additionally, or alternatively, the merchant 102b1, the acquirer 104b, and/or the issuer 108a may store the transaction records in corresponding data structures, or transaction records may be transmitted between parts of system 100. The transaction records may include, for example, payment account numbers or other IDs, amounts of transactions, merchant names, merchant IDs, merchant locations, transaction types, transaction channels, dates/times of the transactions, etc. It should be appreciated that more or less information related to transactions, as part of either authorization or clearing and/or settling, may be included in transaction records and stored within the system 100, at the merchant 102b1, the acquirer 104b, the payment network 106 and/or the issuer 108a.

In the embodiments herein, consumers involved in the different transactions are prompted to agree to legal terms associated with their payment accounts, for example, during enrollment in their accounts, etc. In so doing, the consumers voluntarily agree, for example, to allow merchants, issuers, payment networks, etc., to use transaction data generated and/or collected during enrollment and/or in connection with processing the transactions, for subsequent use in general, and as described herein.

As will be described more hereinafter, the stored transaction data, in data structure 114, for example, may be used to determine statistical relationships between purchases, or purchase propensities, at the merchants 102a, 102b1, and 102b2 in one or more of the regions A and B (and/or at merchants in other regions). Using the determined purchase propensities, predictions may be made about future purchases (or consumer behaviors), and various actions may be taken based on the predictions.

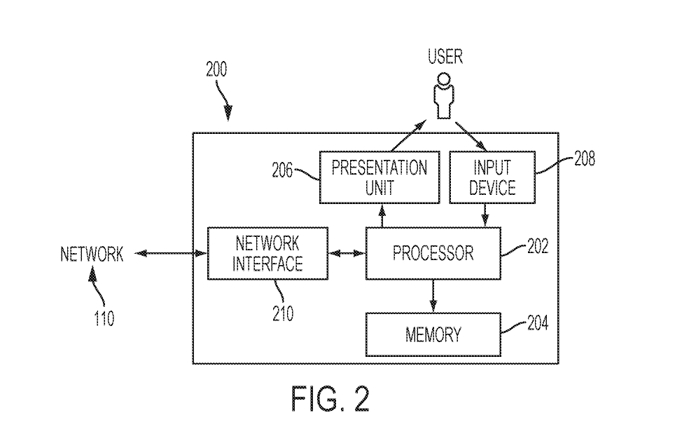

FIG. 2 illustrates an exemplary computing device 200 that can be used in the system 100. The computing device 200 may include, for example, one or more servers, workstations, personal computers, laptops, tablets, smartphones, PDAs, etc. In addition, the computing device 200 may include a single computing device, or it may include multiple computing devices located in close proximity or distributed over a geographic region, so long as the computing devices are specifically configured to function as described herein. However, the system 100 should not be considered to be limited to the computing device 200, as described below, as different computing devices and/or arrangements of computing devices may be used. In addition, different components and/or arrangements of components may be used in other computing devices.

In the exemplary system 100 of FIG. 1, each of the merchants 102a, 102b1, and 102b2, the acquirers 104a and 104b, the payment network 106, and the issuers 108a and 108b are illustrated as including, or being implemented in, computing device 200, coupled to (and in communication with) the network 110. Further, the computing devices 200 associated with these parts of the system 100, for example, may include a single computing device, or multiple computing devices located in close proximity or distributed over a geographic region, again so long as the computing devices are specifically configured to function as described herein.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured, as one or more data structures, to store, without limitation, transaction data (e.g., merchant name/ID, merchant location, account ID, amount spent, transaction type, etc.), purchase propensity model data (e.g., relationships between purchases at various merchants and/or merchant categories in one or more regions, etc.), advertisement/offer data, web-based interfaces (e.g., as defined by web-based applications, websites, etc.), and/or other types of data (and/or data structures) suitable for use as described herein.

Furthermore, in various embodiments, computer-executable instructions may be stored in the memory 204 for execution by the processor 202 to cause the processor 202 to perform one or more of the operations described herein, such that the memory 204 is a physical, tangible, and non-transitory computer readable storage media. Such instructions often improve the efficiencies and/or performance of the processor 202 that is performing one or more of the various operations herein. It should be appreciated that the memory 204 may include a variety of different memories, each implemented in one or more of the functions or processes described herein.

In the exemplary embodiment, the computing device 200 includes a presentation unit 206 that is coupled to (and in communication with) the processor 202 (however, it should be appreciated that the computing device 200 could include output devices other than the presentation unit 206, etc.). The presentation unit 206 outputs information (e.g., purchase propensity model data, advertisement/offer data, etc.), visually, for example, to a user of the computing device 200. It should be further appreciated that various interfaces (e.g., as defined by web-based applications, websites, etc.) may be displayed at computing device 200, and in particular at presentation unit 206, to display certain information. The presentation unit 206 may include, without limitation, a liquid crystal display (LCD), a light-emitting diode (LED) display, an organic LED (OLED) display, an “electronic ink” display, speakers, etc. In some embodiments, presentation unit 206 includes multiple devices.

The computing device 200 also includes an input device 208 that receives inputs from the user (i.e., user inputs) such as, for example, selections of certain advertisement/offer data (e.g., coupons for purchase at nearby merchants, notices of sales going on at similar merchants in the same region, etc.), etc. The input device 208 is coupled to (and in communication with) the processor 202 and may include, for example, a keyboard, a pointing device, a mouse, a stylus, a touch sensitive panel (e.g., a touch pad or a touch screen, etc.), another computing device, etc. Further, in various exemplary embodiments, a touch screen, such as that included in a tablet, a smartphone, or similar device, behaves as both a presentation unit and an input device.

In addition, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks, including the network 110. Further, in some exemplary embodiments, the computing device 200 includes the processor 202 and one or more network interfaces incorporated into or with the processor 202.

Referring again to FIG. 1, the system 100 includes a prediction engine 116 specifically configured, by executable instructions, to analyze the collected historic transaction data stored in the transaction data structure 114 to determine purchase propensity relationships between the merchants 102a, 102b1 and/or 102b2 (and/or other merchants), and/or their merchant categories, in one or more of the regions A and B (and other regions). The system 100 also includes a model data structure 118 that is configured to store purchase propensity models and related data that have been derived from the transaction data analysis. The purchase propensity models may then be used, for example, by the prediction engine 114, in combination with current transaction data to make predictions about future purchases by consumers at the same merchant and/or other merchants in the one or more regions A and B (and other regions), and/or about future purchases in the same merchant category.

In general, the prediction engine 116 rewinds time to a past time, as a particular snapshot time (and transaction data may be summarized based on (or up to) the snapshot time). To simulate future model applications, the prediction engine 116 learns from the transactions that happened before the snapshot time to predict target events (e.g., transactions, etc.) in a specific time interval after the snapshot time. The prediction engine 116 then generates predictive values or ranked propensity scores (via suitable algorithms) to differentiate likelihoods of future target events of each of the consumers (e.g., a transaction at a particular merchant, a transaction in a particular merchant category, etc.). For a specific target event, say a next purchase at merchant 102a, for example, in the next month, each of the consumers with different transaction histories will have different values or scores from other ones of the consumers (since they will likely have different propensities for making a purchase at merchant 102a). In connection therewith, the propensity models stored at the model data structure 118 can be pre-developed and ready for use by the prediction engine 116, as described herein, for example, in connection with generating such values or scores. As described, the propensity models may use historical transaction information, before the snapshot time, about where transactions were made by the consumers, when the transactions were made, what products were involved in the transactions, and price amounts associated with the transactions to predict the likelihood of the future transaction at the particular merchant 102a. As can be appreciated, such propensity probability (or values or scores) of the consumers' future transactions may be useful to marketers and/or merchants (e.g., merchant 102a in the above example, etc.) in understanding demand and input to their marketing strategies. This will be described in more detail hereinafter in connection with method 300.

The prediction engine 116 may be considered a computing device consistent with computing device 200 for purposes of the description herein. In addition, while the prediction engine 116 and the data structure 118 are shown as standalone parts of the system 100 in FIG. 1, they may be associated with (and/or incorporated with) the payment network 106 (e.g., with, or in communication with, the computing device 200 of the payment network 106; etc.), as indicated by the dashed lines in FIG. 1. Further, in other embodiments, the prediction engine 116 may be associated with (and/or incorporated with) other parts of the system 100 (e.g., one of the issuers 108a and 108b, etc.). Moreover, as shown, the prediction engine 116 is separate from, yet interacts with and/or is connected to (and is in communication with) the data structure 114 (which stores the transaction data gathered from the interactions between the consumers, the merchants 102a, 102b1, and 102b2, the acquirers 104a and 104b, and the issuers 108a and 108b). However, this segregation of the prediction engine 116 and the data structure 114 is not required in all embodiments. Still further, in one or more embodiments, the model data structure 118 may be incorporated within one or more other data structures employed in system 100, including, for example, the transaction data structure 114, or even within the prediction engine 116 (e.g., within memory 204 thereof, etc.).

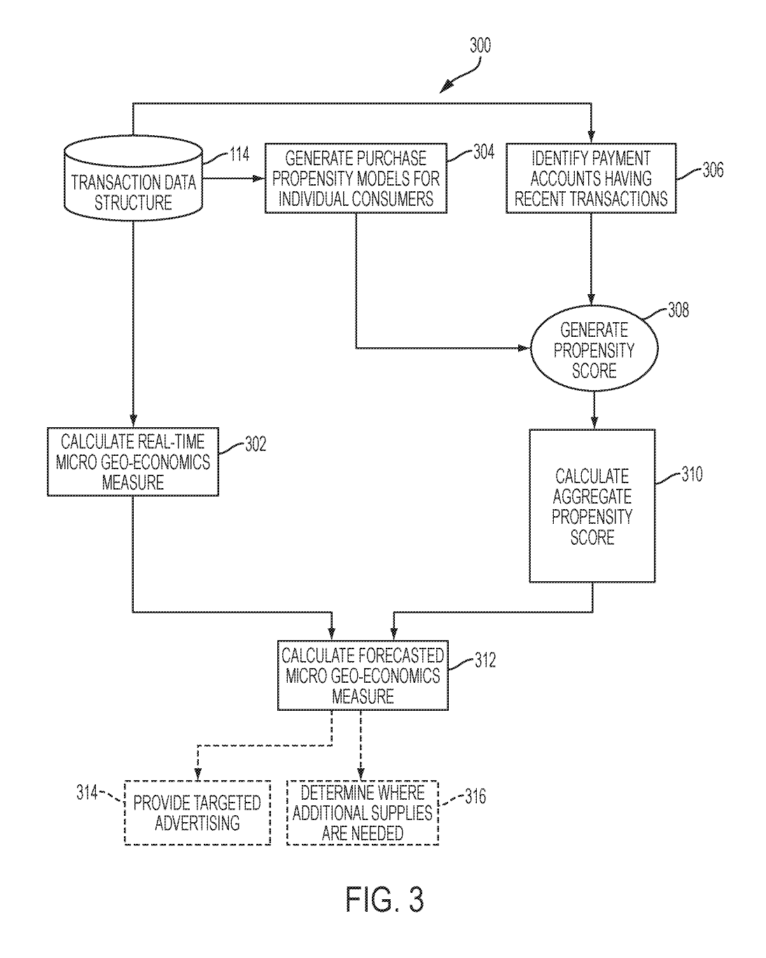

FIG. 3 illustrates an exemplary method 300 for predicting purchase propensities in regions for near-future time intervals using the prediction engine 116 and the transaction data structure 114. The exemplary method 300 is described as implemented in the prediction engine 116 of the system 100, with additional references to other parts such as the payment network 106, etc. However, the method 300 is not limited to the prediction engine 116, or more generally, to the system 100. As such, it should be appreciated that the method 300 may be implemented in other parts of the system 100 or in other systems (not shown). Further, while the method 300 is described with reference to region B of the system 100 in FIG. 1 for ease of description, nothing should be understood to limit the method 300 in such a manner. Further still, the exemplary method 300 is described herein with reference to the computing device 200. However, the methods herein should not be understood to be limited to the exemplary computing device 200. Likewise, the systems and computing devices herein should not be understood to be limited to the exemplary method 300.

In connection with the method 300, Table 1 illustrates exemplary transaction data that may be collected and stored in the transaction data structure 114, and used by the prediction engine 116 as described herein. As shown, the transaction data generally includes a record for each of four transactions (i.e., transaction numbers 1-4). In particular in Table 1, for each record, the transaction data includes a name of the merchant involved in the transaction (i.e., merchants A-D), a date/time of the transaction, a channel for the transaction (e.g., card present, card not present, etc.), an amount of the transaction, an industry associated with the transaction/merchant, a merchant category code (MCC) associated with the transaction/merchant, and a location of the merchant. It should be appreciated that the transaction data included in Table 1 is exemplary in nature and is provided merely for purposes of illustration, and should not be understood to limit the type of transaction data that may be used herein.

TABLE 1

| Transaction | | | | | | | |
|---|---|---|---|---|---|---|---|
| Number | Merchant | Date | Channel | Amt. | Industry | MCC | Loc. |
| 1 | A | 11/20/XXXX | Card | $359.42 | Apparel | 5311 | 123 |
| | | 1:25PM | Present | | | | |
| 2 | B | 11/24/XXXX | Card | $192.32 | Discount | 5411 | 122 |
| | | 5:23PM | Present | | | | |
| 3 | C | 12/24/XXXX | Card | $72.9 | Auto | 5541 | 124 |
| | | 6:21PM | Present | | Fuel | | |
| 4 | D | 12/24/XXXX | Card | $29.32 | Food | 5814 | 124 |
| | | 6:25PM | Present | | | | |

The prediction engine 116 initially accesses transaction data from the transaction data structure 114 (including, for example, the transaction data included in Table 1 in the above example). The prediction engine 116 may access all available transaction data for a given region or regions (e.g., for region B of the system 100, etc.), or for a particular grouping of merchants (e.g., merchants 102a, 102b1, and 102b2 in the system 100, etc.), or for a particular class/category of merchants, etc. In addition (or alternatively), the prediction engine 116 may access transaction data for (e.g., limit the accessed transaction data to, etc.) a particular time period (e.g., prior to a snapshot time, etc.), and/or for particular categories of transactions (e.g., based on industry, MCC, etc.), etc. In some embodiments, the prediction engine 116 may also retrieve any accessed transaction data from the transaction data structure 114, and store the retrieved transaction data in data structure 118 for subsequent use as described herein.

At 302 in the method 300, upon accessing the desired transaction data, the prediction engine 116 uses the accessed transaction data to generate a real-time micro geo-economics (MGE) measure. The MGE measure is a dynamic measure of retail business sales or sales potential (or category-based local sales) in a target region (e.g., for region B in the system 100, etc.) at a target time (or interval). In connection therewith, the MGE measure incorporates the transaction data from all of the individual consumers who have made purchases in the target region during the target time (or interval). Further, the MGE measure may be generated for a past time period and/or recent time period using, for example, the transaction data in the transaction data structure 114.

With that said, and as an example, the MGE measure may be represented by exemplary equation (1), as a summation of total purchase amounts for multiple transactions made by multiple consumers within a target region over a target time interval (i.e., a summation of each individual qualifying time-location purchase combination for multiple consumers within the target region and the target time interval):

$$A ( t , R ) = {\sum }_{{t < {t}_{i} < t + Δ t}_{R < {R}_{i} < R + Δ R}} A ( {t}_{i } , {R}_{i} ) \qquad ( 1 )$$

In equation (1), A(tᵢ, Rᵢ) represents a purchase amount for a transaction by a consumer (i) that happened at time tᵢ and at location/region Rᵢ, and A(t, R) represents an overall transaction amount (or sum) that happened at all of the available locations near the target region R and during one time interval before the current time, for all available consumers (e.g., for all available transaction data from the transaction data structure 114, etc.). Here, t is the target time over which the analysis is performed, and R is the particular target region for analysis (e.g., region B of the system 100, etc.). The time interval (Δt), then, may be a certain time of interest, for example, 30 minutes, one hour, one day, one week, one month, one quarter, one year, etc. Further, the target time (t) may include a past time period, or it may include a recent time period. And, the particular target region (R) includes a central region as well as nearby regions, for example, that may be within a predefined distance of the central region (e.g., 0.1, 0.5, etc. miles (e.g., radius, etc.) from the central region; etc.).

In connection therewith, Table 2 illustrates an example application of equation (1). In this example, the target time (t) is 11/12/XXXX at 2:00 PM, and the target location (R) is Grand Center, NY. In addition, nearby regions to Grand Center, NY, to be considered in the MGE measure calculation, are within a 0.5 mile radius of Grand Center, NY, and the time interval (Δt) for consideration is 0.5 hours prior to the target time (t).

TABLE 2

| Consumer | t-ti (hour) | R-Ri (mile) | Amount ($) | Qualified |
|---|---|---|---|---|
| 1 | 0.3 | 0.2 | $35.20 | Yes |
| 1 | 0.6 | 0.3 | $23.30 | No |
| 1 | 0.7 | 2.5 | $94.30 | No |
| 2 | 0.3 | 0.2 | $93.20 | Yes |
| 3 | 0.2 | 0.1 | $25.10 | Yes |

In Table 2, the qualified total spend, A(t, R) (i.e., the MGE measure for this example), within one past time interval of 0.5 hours from the target time of 11/12/XXXX at 2:00 PM and for transactions within a 0.5 mile radius of Grand Center, NY, for example, is $153.50 (i.e., the sum of the qualified transactions from Table 2). Thus, in this example, the dynamic measure of retail business sales or sales potential (or category-based local sales) for Grand Center, NY, at the target time is $153.50.

With reference again to FIG. 3, also in the method 300, upon accessing the transaction data, the prediction engine 116 uses the transaction data to develop purchase propensity models for future time intervals, at 304, for each of the individual consumers associated with the MGE measure at 302. A different propensity model may be created for each consumer (e.g., based on different variables that separate and rank the consumers in terms of future targeting response or behavior, etc.). In addition, different propensity models may be generated for different merchant categories. Generally, the purchase propensity models will differentiate consumers with a high propensity for purchase from consumers with lower propensity for purchase. For example, the purchase propensity models may be based on relationships between different merchants in the target region (e.g., relationships between merchants 102b1 and 102b2, in region B in the system 100, etc.) and/or merchants in different merchant categories. Further, the purchase propensity models may be created based on transaction factors such as, and without limitation, time of day, day of the week, special events (e.g., concerts, sporting events, food festivals, sales, etc.), holidays, etc. As can be appreciated, given enough transaction information for a particular consumer, patterns of purchases specific to that consumer may be detected. The patterns may then be reflected by a function, for example, to model the consumer's propensity to make a purchase in the near future based on recent purchases made. With that said, if a statistical relationship between two factors is evident from the transaction data of the target region and/or other regions, a purchase propensity model may be created to take the relationship into account.

The prediction engine 116 further uses the transaction data to identify, at 306, which of the consumers associated with the MGE measure at 302, and more specifically which of their payment accounts, have made (or include) transactions in the target region within a target time (e.g., within region B in the system 100 within the last week, etc.). This may be consistent with the prior operation of initially accessing transaction data at the transaction data structure 114, or it may include a further filtering of such data. In any case, the target region again includes the region for which an overall purchase propensity is being generated (e.g., the region (R) for which the MGE measure is generated, etc.). And, the target time is a certain interval of time (e.g. 30 minutes, 1 hour, 1 day, etc.) which may immediately or closely precede the present time, such that transaction data from the target time may be used in forming an accurate purchase propensity prediction for the target region in the near future. Alternatively, the target time may be on a larger scale (e.g. weeks, months, quarters, years, etc.) (such as for seasonal purchasing patterns, etc.). In some embodiments, the prediction engine 116 may gather only transaction data which is associated with the developed propensity models of 304. Here, if a developed propensity model is only concerned with merchant categories, other data points in the transaction data, such as specific product purchase data, may be ignored.

The prediction engine 116 then generates propensity scores, at 308, for each of the consumers based on the purchase propensity models (from 304) and the recent transaction data (from 306). In generating the scores, the prediction engine 116 applies the patterns of the propensity models, which are based on the applicable transaction data from the transaction data structure 114, to the specific recent transaction data to form predicted purchase propensities. For instance, a propensity model may indicate that a consumer who purchases gas at a first merchant is likely (e.g., is 75% likely, etc.) to purchase groceries at a second merchant within the next hour of time. If the recent transaction data, from 306, includes a consumer who has purchased gas at the first merchant recently, the prediction engine 116 generates a score for the consumer as having a high propensity to purchase groceries at the second merchant within the next hour based on the purchase propensity model.

The propensity score (or predicted purchase propensity) for an individual consumer may be generated using exemplary equation (2), based on transactions by the consumer involving a particular merchant category and over a target time:

Â_{c,i}(t)=F{P₁,P₂, . . . Pₖ} (2)

Equation (2) represents a general form of a predicted propensity score Â_{c,i}(t), and takes into account one or more of the purchase propensity models generated by the prediction engine 116 and current/recent transaction data identified for the consumer. In this example, i represents the individual consumer for which the score is being calculated, c represents the particular merchant category of transactions at issue (e.g. grocery stores, gas stations, clothing stores, shoe stores, etc.), t represents the target time over which the transactions are being reviewed, and P represents recent transactions for the consumer within the particular merchant category and during the target time (e.g., as determined at 306 in the method 300, etc.). F is a general model function of each of the consumer's purchase transactions P₁, P₂, . . . Pₖ, based on one or more of the purchase propensity models for the consumer to make a purchasing prediction for the merchant category (c) (e.g., such as the models developed at 304 in the method 300, etc.). The predicted value or score Â_{c,i}(t) is then a rank schema that the likelihood of future purchases can be measured. For example, a consumer with a higher score, for example, 0.8 (or 80% likely to purchase), is considered more likely to purchase than a customer with a lower score, for example, 0.5 (or 50% likely to purchase).

In connection with equation (2), the general model function (F) may include any suitable model function (e.g., linear functions, non-linear functions, etc.). As an example, and without limitation, the model function (F) may include a linear function such as the one represented by exemplary equation (3):

Y=0.5+0.2×₂+0.1x₄+0.3x₁₀₁ (3)

As shown in equation (3), several variables can be constructed from the accessed transaction data for the consumer. A listing of example variables are provided in Table 3, with it understood that any desired number, type, etc. of such variables may be included and/or used in the equation (3) (even through not expressly shown or included in equation (3) herein). Table 3 also includes a listing of coefficients applied to each of the different variables, identifying a generally importance of the particular variables in the calculation. As can be seen in connection with the coefficients, of the vast number of constructed variables, few are considered statistically very significant. However, it should be appreciated that the importance of the different variables may be changed, by modifying the different coefficients, for different propensity score calculations (e.g., based on the particular region, time, etc.). As such, in this example, the predicted propensity score (A) of equation (2) can be generated as a function of Y of equation (3).

TABLE 3

| | | Equation |
|---|---|---|
| Variable | Variable Description | Coefficient |
| | Constant | 0.5 |
| x₁ | Number of Transaction in Apparel in last | |
| | X Months | |
| x₂ | Total Dollar Amount in Apparel in last | 0.2 |
| | X Months | |
| x₃ | Average Transaction Time per Month over | |
| | last Year | |
| x₄ | Average Transaction Time per Month in | 0.1 |
| | Apparel over last Year | |
| . . . | . . . | |
| x₁₀₁ | . . . | 0.3 |
| . . . | . . . | |
| x₁₀₀₀₀ | . . . | |

With continued reference to FIG. 3, the predication engine 116 next calculates an aggregate propensity score, for all of the consumers, at 310, to generally form a regional predicted purchase amount for the target region. In particular, the regional predicted purchase amount includes purchase amounts and/or propensity scores for all individual consumers in the target region during the target time, expressed as a sum of the predicted purchase propensity scores for each of the individual consumers for each merchant category that is present in the target region.

The aggregate propensity score for all consumers making transactions in a target region may be calculated using exemplary equation (4) and exemplary equation (5), based on a sum of the propensity scores for each individual one of the consumers (e.g., from equation (2), etc.):

$$\begin{matrix}{U}_{c} ( t , R ) = {\sum }_{{i}_{i ⋐ R , c ⋐ R}} {\hat{A}}_{c , i} ( t ) & ( 4 ) \\ U ( t , R ) = {\sum }_{{i , c}_{i ⋐ R , c ⋐ R}} {\hat{A}}_{c , i} ( t ) & ( 5 )\end{matrix}$$

In equations (4) and (5), for example, U_{c}(t, R) and U(t, R) represent the aggregate propensity scores, i represents the individual consumer for which each score is being summed, c represents the particular merchant category, R represents the target region, and t represents the target time over which transactions are being reviewed. As can be appreciated, not all categories (c) of merchants may exist in the target region (R). For example, the aggregated total sales for the target region (R) may only include categories (c) of merchants that exist within the region during the time interval (t). The illustrated equation (2) above takes this feature into account.

Tables 4 and 5 illustrate an example application of equations (4) and (5) for transaction data for three consumers 1-3. As shown, there is a propensity score (A) for each consumer for each merchant category A-E, indicating a propensity for the consumer to make a subsequent purchase in the particular category. Combining this with the consumer location and store availability (i.e., located within region R), the prediction engine 116 can summarize predicted propensity by category and total, for all consumers. In particular in this example, based on equation (4), a local propensity demand for merchant categories A, C, and E can be generated by the prediction engine 116. In particular, as shown in Table 5, the local propensity demand for merchant category A is 1.3; the local propensity demand for merchant category C is 0.4; and the local propensity demand for merchant category E is 0.2. And, based on equation (5), a local total propensity demand can be generated for the target region (R). As shown in Table 5, the local total propensity demand in this example is 1.9.

TABLE 4

| | Propensity | Propensity | Customer Within | Category Store |
|---|---|---|---|---|
| | By | Score | Region (R) at | Within Region |
| Consumer | Category (c) | (Â) | time(t) | (R) |
| 1 | A | 0.8 | Yes | Yes |
| 1 | B | 0.4 | Yes | No |
| 1 | C | 0.2 | Yes | Yes |
| 1 | D | 0.5 | Yes | No |
| 1 | E | 0.1 | Yes | Yes |
| 1 | . . . | . . . | . . . | . . . |
| 2 | A | 0.1 | No | Yes |
| 2 | B | 0.3 | No | No |
| 2 | C | 0.2 | No | Yes |
| 2 | D | 0.6 | No | No |
| 2 | E | 0.7 | No | Yes |
| . . . | . . . | . . . | . . . | . . . |
| 3 | A | 0.5 | Yes | Yes |
| 3 | B | 0.3 | Yes | No |
| 3 | C | 0.2 | Yes | Yes |
| 3 | D | 0.3 | Yes | No |
| 3 | E | 0.1 | Yes | Yes |
| 3 | . . . | . . . | . . . | . . . |

TABLE 5

| | Sum Propensity |
|---|---|
| Category | Score |
| A | 1.3 |
| C | 0.4 |
| E | 0.2 |
| . . . | . . . |
| Total | 1.9 |

Then, at 312 in the method 300, the prediction engine 116 calculates a forecasted (or predicted) MGE measure for the target region, based on the current observed MGE measure (from 302) and the aggregate propensity score (from 310). The forecasted MGE measure generally includes an overall predicted purchase propensity for the target region for the target time interval.

The forecasted MGE measure may be calculated using exemplary equation (6):

\hat{A}(t+Δt,R)=φ{U(t,R),A(t,R),A(t−Δt,R), . . . ,A(t−kΔt,R)} (6)

In equation (6), Â(t+Δt, R) represents the forecasted MGE measure, in which R represents the target region and t+Δt represents the target time for which the forecasted MGE measure is to be generated. In addition, φ is a time series model function which presents the forecasted MGE measure as a function of predicted future propensity (e.g., the propensity scores generated at 310, etc.) and recent MGE measures (e.g., the MGE measure generated at 302, etc.). For example, the forecasted MGE measure may be a linear function of predicted propensity, current MGE, and t−kΔt MGE, as represented by equation (7), where α, β, and γ are model parameters/coefficients:

\hat{A}(t+Δt,R)=αU(t,R)+βA(t,R)+γA(t−kΔt,R) (7)

Table 6 illustrates an example application of equation (7). Again, A(t, R) is the propensity score or intensity that measures relative rank of propensity of transaction count or dollar at location R and time t, and U(t, R) is the aggregate propensity score. As such, Table 6 illustrates that an example MGE measurement A at location R and at time t may normally be around 0.5 to 0.8. But at time t interval, the MGE intensity increases. From the model, it is then forecasted that the intensity will further increase, at t+1, to about 2.7. In this example, the model parameters α, β, and γ have values of 0.2, 0.5, and 0.3, respectively, and k has a value of 4 and Δt has a value of 1.

TABLE 6

| t | A(t, R) | U(t, R) |
|---|---|---|
| t − 4 | 0.509932 | 0.10521 |
| t − 3 | 0.769116 | 0.134235 |
| t − 2 | 0.539001 | 0.022884 |
| t − 1 | 0.078294 | 0.084872 |
| t | 1.844748 | 1.162903 |
| t + 1 | 2.71088 | |

Referring again to FIG. 3, once the forecasted MGE measure for the target region is calculated, the prediction engine 116 may publish the results, as appropriate, for subsequent use.

For example, at 314 in the method 300, the forecasted MGE measure may be used to provide targeted advertising to consumers, etc. The advertising may include localized internet ads, transmission of electronic coupons or other offers, or the like. Consumers may receive notifications on personal devices and/or mobile devices (e.g., mobile phones, laptops, tablets, etc.) regarding sales going on at nearby merchants based on the predicted spending at merchants of that category in the region. As an example, if transaction data indicates that a sporting event is currently occurring in a region, and the forecasted MGE measure indicates a high likelihood of purchases at bars in the region within the next two hours (or once the sporting event ends) as a result of the sporting event, bars within the region may promote specials and/or “happy hour” via targeted advertising to attempt to take advantage of the predicted spending.

Alternatively, at 316, the forecasted MGE measure may be used to determine where additional supplies will be needed in the target region. For instance, in the sporting event example, the gathered transaction data may indicate a large influx of ticket purchases to the sporting event prior to the event. As a result of the ticket purchase data, the forecasted MGE measure may predict the increased purchasing at bars in the region of the sporting event after the event is over, such that bar owners in the area may increase their stock of supplies on hand in anticipation of the increased business from the sporting event. In some embodiments, orders for supplies may be automatically placed based on the forecasted MGE measure.

Additional applications of the systems and methods herein may include, for example, taking into account upcoming local events, etc. For example, an upcoming graduation ceremony may cause an influx of consumers to a particular region. In accordance therewith, the forecasted MGE for some categories like restaurants and taxis may increase dramatically. As can be appreciated, the sudden changes from normal business may present opportunities for marketers and businesses operating in that region.

In view of the above, the systems and methods herein may enable a payment network to predict future purchase propensities in a region based on gathered transaction data. The payment network may use past transaction data to generate purchase propensity models based on purchasing patterns found within the transaction data. By applying the purchase propensity models to the most current data for a region, the payment network may develop a dynamic consumer function for the region that may be used to determine how to target advertisements, where additional supplies may be needed, etc.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by: (a) generating, by a computing device, a purchase propensity model based on historic transaction data, (b) determining, by the computing device, a recent sales value of the region based on a set of transactions that occurred in the region during a recent time interval, (c) determining, by the computing device, a set of consumer accounts that include transactions in the region during the recent time interval, (d) calculating, by the computing device, propensity scores associated with each of the consumer accounts, said propensity scores being based on the purchase propensity model, (e) combining, by the computing device, the propensity scores of each of the consumer accounts into an overall purchase propensity, and (f) determining, by the computing device, a predicted sales value for the region based on the recent sales value of the region and the overall purchase propensity, whereby businesses in the region make business decisions confident that the predicted sales value is accurate.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in predicting purchases in a region, the method comprising:
generating, by a computing device, a purchase propensity model based on historic transaction data;
determining, by the computing device, a recent sales value of the region based on a set of transactions that occurred in the region during a recent time interval;
determining, by the computing device, a set of consumer accounts that include transactions in the region during the recent time interval;
calculating, by the computing device, propensity scores associated with each of the consumer accounts, said propensity scores being based on the purchase propensity model;
combining, by the computing device, the propensity scores of each of the consumer accounts into an overall purchase propensity; and
determining, by the computing device, a predicted sales value for the region based on the recent sales value of the region and the overall purchase propensity.

2. The computer-implemented method of claim 1, further comprising directing targeted advertising in the region based on the predicted sales value for the region.

3. The computer-implemented method of claim 1, further comprising:
determining at what location additional supplies will be needed in the region based on the forecasted sales value for the region; and
placing orders for the determined additional supplies.

4. The computer-implemented method of claim 1, wherein the purchase propensity model includes a propensity for consumers to make purchases at a first merchant within the region after recently making purchases at a second merchant within the region.

5. The computer implemented method of claim 4, wherein the first merchant is associated with a first merchant category and the second merchant is associated with a second merchant category different from the first merchant category.

6. The computer implemented method of claim 1, wherein the purchase propensity model is based on a relationship between a first merchant category and a second merchant category.

7. The computer implemented method of claim 6, wherein the first merchant category relates to an industry of a first merchant and the second merchant category relates to an industry of a second merchant.

8. A non-transitory computer readable storage media including executable instructions for predicting purchase propensity within a region based on payment account transaction data, which when executed by at least one processor, cause the at least one processor to:
access a purchase propensity model based on historic transaction data;
determine a recent sales value of the region based on a set of transactions that occurred in the region during a recent time interval;
determine a set of consumer accounts that include transactions in the region during the recent time interval;
apply the purchase propensity model to each of the consumer accounts to form consumer purchase propensities for each of the consumer accounts;
combine the consumer purchase propensities of each of the consumer accounts into an overall purchase propensity; and
determine a forecasted sales value for the region based on the recent sales value of the region and the overall purchase propensity.

9. The non-transitory computer readable storage media of claim 8, further including executable instructions, which when executed by the at least one processor, cause the at least one processor to direct targeted advertising in the region based on the forecasted sales value for the region, the targeted advertising including at least one of advertisements, offers, and coupons to mobile devices of consumers in the region.

10. The non-transitory computer readable storage media of claim 8, further including executable instructions, which when executed by the at least one processor, cause the at least one processor to access the historic transaction data and generate the purchase propensity model based on the historic transaction data.

11. The non-transitory computer readable storage media of claim 10, wherein the purchase propensity model includes a propensity for consumers to make purchases at merchants of a first merchant category after recently making purchases at merchants of a second, different merchant category.

12. The non-transitory computer readable storage media of claim 8, wherein the region includes a central region and regions within a predefined distance of the central region.

13. The non-transitory computer readable storage media of claim 8, further including executable instructions, which when executed by the at least one processor, cause the at least one processor to:
determine at what location additional supplies will be needed in the region based on the forecasted sales value for the region; and
place orders for the determined additional supplies.

14. The non-transitory computer readable storage media of claim 8, wherein the recent sales value indicates the occurrence of a special event in the region and the purchase propensity model includes a propensity that accounts for the occurrence of the special event, such that the forecasted sales value for the region accounts for the occurrence of the special event.

15. The non-transitory computer readable storage media of claim 8, wherein the purchase propensity model includes a propensity for consumers to make purchases at a second merchant within the region after recently making purchases at a first merchant within the region.

16. A system for use in predicting consumer purchasing behavior, the system comprising:
a memory; and
at least one processor in communication with the memory, the at least one processor configured to:
access historical transaction data for multiple consumers for a time interval prior to a target time and for a target region;
generate multiple purchase propensity models based on the historical transaction data and store the purchase propensity models in the memory, the purchase propensity models indicating likelihoods that the consumers will perform future transactions at particular merchants and/or at particular categories of merchants;
access current transaction data for a transaction made by a target one of the consumers at a merchant within the target region and within an interval after the target time; and
generate a propensity score for the target consumer based on the current transaction and at least one of the purchase propensity models, to thereby predict if the consumer will perform a future transaction at one of the particular merchants and/or at one of the particular categories of merchants, and store the propensity score in the memory.

17. The system of claim 16, wherein the at least one processor is further configured to:
access current transaction data for transactions made by multiple target consumers at within the target region and within the interval after the target time;
generate propensity scores for each of the target consumers based on the current transactions and at least one of the purchase propensity models and store each of the propensity scores in the memory; and
aggregate the propensity scores for each of the target consumers to thereby provide a regional propensity score for the target region, to thereby predict if one or more consumer will perform a future transaction within the target region.

18. The system of claim 17, wherein the at least one processor is further configured to:
generate a real-time micro geo-economics (MGE) measure, where the MGE measure includes a dynamic measure of retail business sales or sales potential in the target region at or before the target time; and
calculate a forecasted MGE measure for the target region, based on the real-time MGE measure the regional propensity score, the forecasted MGE measure including an overall predicted purchase propensity for the target region for the interval after the target time.

19. The system of claim 18, wherein the target region includes a central region and regions within a predefined distance of the central region.

20. The system of claim 19, further comprising a payment network configured to process purchase transactions by consumers to payment accounts, the at least one processor associated with the payment network.
